(19) United States
(12) Patent Application Publication
(10) Pub. No.: US 2006/0167206 A1
(43) Pub. Date: Jul. 27, 2006

(54) Fluorine-modified polyurethane resins containing one or two constituents, method for the production thereof, and use of the same

(76) Inventors: Alois Maier, Engelsberg (DE); Norbert Steidl, Kienberg (DE); Stefan Ingrisch, Truchtlaching (DE); Frank Weinelt, Burgkirchen (DE)

Correspondence Address: FULBRIGHT & JAWORSKI, LLP, 666 FIFTH AVE, NEW YORK, NY, 10103-3198, US

(21) Appl. No.: 10/563,539

(22) PCT Filed: Jul. 6, 2004
(86) PCT No.: PCT/EP04/07391

§ 371 Date: Dec. 20, 2005

(30) Foreign Application Priority Data
Jul. 11, 2003 (DE) 103 31 483.0

(51) Int. Cl. C08G 18/00

(52) U.S. Cl. 528/44

(57) ABSTRACT

A description is given of a fluorine-modified one- or two-component polyurethane resin having improved surface properties, which is obtainable by a) preparing a fluorine-modified polyurethane prepolymer having free isocyanate groups or free amino and/or hydroxyl groups, or a fluorine-modified polyol mixture having free hydroxyl groups (binder), and by b) preparing a fluorine-modified polyurethane resin having a polymer-bonded fluorine content of 1% to 4% by weight in the system as a whole by reacting the fluorine-modified polyurethane prepolymer from stage a₃) in the case of a one-component application with atmospheric moisture, or reacting the fluorine-modified polyurethane prepolymer or polyol mixture (binder) in the case of a two-component application with a crosslinker component (D) (curing agent), with a formulating component (F)(ii) in the presence if desired of a solvent component (L)(iii) and also of a catalyst. Through the use of suitable fluorinated macromonomers in the one- or two-component polyurethane resins of the invention it is possible to produce hard coating systems and/or surfaces having very low surface tensions and very high contact angles. Furthermore, the dirt pickup tendency of these polyurethane resins is also significantly reduced as compared with the known prior art.

The present invention relates to fluorine-modified one- or two-component polyurethane resins having outstanding permanent dirt- and water-repellent surface properties and also very good material properties and processing properties, to processes for preparing them, and to their use.

Polyurethane-based high-performance coating materials consisting of a polyisocyanate and an isocyanate-reactive component, such as a higher molecular mass polyol, are common knowledge. Although they exhibit very good material properties, they possess high surface energies and are therefore not easy to clean. The increasing demand for dirt- and water-repellent coatings has led to the development of fluorine-containing compositions which either are admixed to the coating systems (as described in WO 99/26994) or are applied reversibly to coating systems (cf. DE 100 63 431 C1).

By means of a chemical modification to the polyurethane systems through the deliberate insertion of a pendant fluorinated building block (diol component) into the polyurethane matrix it is possible to unite the specific surface properties of the fluorinated compounds with the individual properties of the base polyurethanes, so giving rise to dirt and water repellency properties and leading to improved cleanability. It proves advantageous in this context that only small amounts of the often expensive fluorine compounds are needed in order to obtain the desired surface properties.

Also, despite fluorine modification, compatibility exists with the customary curing-agent systems.

Fluorinated polyurethane systems and their use for modifying the surface properties of coatings, such as imparting oil and/or water repellency, have been known for a very long time already from the patent literature.

EP 0 405 534 A1 describes polyurethanes comprising hydroxy-functional (per)fluoropolyethers for treating stone surfaces, but these polyurethanes do not form true films.

Hydrophilic polyurethane films, coated with fluorine-modified polymers based on perfluoroalkyl acrylates or methacrylates, with high vapor permeability rates, for oil repellency and water repellency are known from WO 97/36951 A1.

U.S. Pat. No. 4,504,401 B1 discloses low molecular mass urethanes containing perfluoroalkyl groups for the dirt-repellent finishing of fiber products such as carpets.

EP 0 702 041 A1 describes polyisocyanates modified with fluorinated monoalcohols and containing allophanate groups and isocyanurate groups, these polyisocyanates, in compositions for 1K [one-component] or 2K [two-component] coating systems, having surface energies of between 19.4 and 43.7 dynes/cm.

EP 0 719 809 A1 discloses similar fluorine-modified polyisocyanates and also blends with other, nonfluorinated polyisocyanates, the fluorine in this case being introduced by way of fluorine components having one or more hydroxyl groups. Their use in coating compositions leads to films having surface energies similar to those described in EP 0 702 041 A1. Fluorine-modified urethane systems consisting of a fluorinated polyol with one or more hydroxyl groups and polyisocyanates with allophanate structures and isocyanurate structures, in a molecular weight ratio of 4:1 to 1:10, are known from EP 0 566 037 A2. These systems, used as a curing component, lead to clear films.

DE 195 47 448 A1 discloses abrasion-resistant urethane coating compositions with reduced friction, based on fluorinated alcohols, nonfluorinated polyols, and blocked polyisocyanates, and also at least one amine crosslinker. Because of the blocked polyisocyanates, however, the coating composition must be heated beforehand to above 120° C. before crosslinking with polyamine components can take place.

Compositions for coatings based on (per)fluoropolyethers (PFPE) are described in EP 1 116 759 A1. They comprise, besides solvents, bifunctional (per)fluoropolyetherdiols in conjunction with IPDI trimers. The (per)fluoropolyethers in this specification are not incorporated pendantly.

Fluorinated branched oligourethanes prepared from monomers and/or macromonomers such as polyisocyanate in blocked form, a hydrophilic alcohol or thiol component, mono- and difunctional hydroxyl (per)fluoropolyether alcohols, and also monofunctional (per)fluoroalkyl alcohols, and also chemically crosslinkable alcohol and/or thiol components, are disclosed by the specification EP 1 059 319 A2. Here again the (per)fluoropolyether compounds are not pendant.

The present invention was based, therefore, on the object of developing fluorine-modified one- or two-component polyurethane resins having improved surface properties for the permanent oil- and water-repellent surface treatment or modification of mineral and nonmineral substrates for a variety of application fields, these resins not having the stated disadvantages of the prior art but instead possessing good performance properties and at the same time being preparable in due consideration of environmental, economic, and physiological aspects.

This object has been achieved in accordance with the invention through the provision of fluorine-modified one- or two-component polyurethane resins having improved surface properties, which have been prepared by
a) preparing a fluorine-modified polyurethane prepolymer having free isocyanate groups or free amino and/or hydroxyl groups, or a fluorine-modified polyol mixture having free hydroxyl groups (binder), where
a₁) a fluorine-modified macromonomer (A1) having two or more amino and/or hydroxyl groups that are reactive toward isocyanate groups and having a molecular mass of 500 to 2000 daltons, a higher molecular mass polyol component (A2) having two or more hydroxyl groups that are reactive toward isocyanate groups and having a molecular mass of 500 to 6000 daltons, and a low molecular mass polyol component (A3)(i) having two or more hydroxyl groups that are reactive toward isocyanate groups and having a molecular mass of 50 to 499 daltons
   either
   is reacted with a polyisocyanate component (B)(i), consisting of at least one diisocyanate, polyisocyanate, polyisocyanate derivative or polyisocyanate homolog having two or more (cyclo)aliphatic or aromatic isocyanate groups of same or different reactivity, in the presence if desired of a solvent component (L)(i) and in the presence if desired of a catalyst,
   or
   if desired, is blended in the presence of a solvent component (L) (i) and in the presence if desired of a catalyst,
a₂) the fluorine-modified polyurethane prepolymer or polyol mixture from stage a₁) is reacted if desired with an unmodified or fluorine-modified functionalizing component (C)(i) having one or more amino and/or hydroxyl groups that are reactive toward isocyanate groups and/or one or more isocyanate groups that are reactive toward hydroxyl groups and having a molecular mass of 50 to 2500 daltons, selected from the groups of the (cyclo)aliphatic and/or aromatic polyols and/or polyamines and/or polyamino alcohols and/or reactive polyhedral oligomeric polysilsesquioxanes (POSS) of the general formula (RSiO_{1.5})ₙ with n=4, 6, 8, 10, 12 and R=any organic residue having 1 to 100 C atoms and 0 to 50 N and/or 0 to 50 O and/or 0 to 50 F and/or 0 to 50 Si and/or 0 to 50 S atoms and a molar mass of 250 to 25 000 daltons,
a₃) the fluorine-modified polyurethane prepolymer or polyol mixture from stages a₁) or a₂) is admixed with a formulating component (F)(i),
   and finally
b) by preparing a fluorine-modified polyurethane resin having a polymer-bonded fluorine content of 1% to 4% by weight in the system as a whole by reacting the fluorine-modified polyurethane prepolymer from stage a₃) in the case of a one-component application with atmospheric moisture, or the fluorine-modified polyurethane prepolymer or polyol mixture from stage a₃) (binder) in the case of a two-component application with a crosslinker component (D) (curing agent), with a formulating component (F)(ii) in the presence if desired of a solvent component (L)(iii) and also of a catalyst, using as crosslinker component (D) in the case of the polyol mixture from stage a₃) a polyisocyanate component (B)(iii) consisting of at least one diisocyanate, polyisocyanate, polyisocyanate derivative or polyisocyanate homolog having two or more (cyclo)aliphatic or aromatic isocyanate groups of same or different reactivity and in the case of the polyurethane prepolymer a polyisocyanate component (B)(iii) or a low molecular mass polyol component (A3) (ii) having two or more hydroxyl groups that are reactive toward isocyanate groups and having a molecular mass of 50 to 499 daltons and/or a low molecular mass polyamine component (E) having two or more (cyclo)aliphatic or aromatic amino groups that are reactive toward isocyanate groups and having a molecular mass of 50 to 500 daltons.

Surprisingly it has been found that through the use of suitable fluorinated macromonomers in the one- or two-component polyurethane resins it is possible to obtain not only hard coating systems or surfaces having very low critical surface tensions γ_{c} (lower than Teflon with 18.6 mN/m) and very high contact angles θ (in the range of Teflon® with 111°) but that also these systems and surfaces, respectively, exhibit a markedly reduced dirt pickup propensity as compared with the known prior art. This profile of properties is obtained even with very low amounts of fluorine (1% to 4% by weight based on the formulated system as a whole) and/or with very small amounts of fluorinated macromonomers. Critical to this is that the one-component or two-component polyurethane resins have covalently bonded fluorinated side chains which can be introduced via suitable macromonomers. Moreover, the fact that the fluorine-modified one- or two-component polyurethane resins can also be prepared without solvent or in a low-solvent fashion was not foreseeable.

The fluorine-modified one- or two-component polyurethane resins having improved surface properties, of the invention, are defined by their multistage preparation process.

In reaction stage a) a fluorine-modified polyurethane prepolymer having free isocyanate groups and/or free amino and/or hydroxyl groups or a fluorine-modified polyol mixture is prepared by reacting in stage a₁) a fluorine-modified macromonomer (A1) together with a higher molecular mass polyol component (A2) and also a low molecular mass polyol component (A3)(i) either with a polyisocyanate component (B)(i) in the presence if desired of a solvent component (L)(i) and a catalyst or blending the fluorine-modified macromonomer (A1), the higher molecular mass polyol component (A2), and the low molecular mass polyol component (A3)(i) in the presence if desired of a solvent component (L)(i) and of a catalyst. The fluorine-modified polyurethane prepolymer or polyol mixture from stage a₁) can be reacted if desired with an unmodified or fluorine-modified functionalizing component (C)(i). In the subsequent stage a₃) the fluorine-modified polyurethane prepolymer or polyol mixture from stages a₁) or a₂) is admixed with a formulating component (F)(i).

Subsequent preparation of the fluorine-modified polyurethane resin as per stage b) takes place by reacting the fluorine-modified polyurethane prepolymer from stage a₃) in the case of a one-component application with atmospheric moisture or reacting the fluorine-modified polyurethane prepolymer or polyol mixture from stage a₃) (binder) in the case of a two-component application with a crosslinker component (D) (curing agent), with a formulating component (F)(ii), in the presence if desired of a solvent component (L)(iii) and also of a catalyst. In the case of the polyol mixture from stage a₃) a polyisocyanate component (B)(iii) is used as crosslinker component (D), while in the case of the polyurethane prepolymer a polyisocyanate component (B)(iii) or a low molecular mass polyol component (A3)(ii) and/or a low molecular mass polyamine component (E) is employed.

Preference is given to using a fluorine-modified macromonomer (A1) prepared by
c₁) reacting a fluoro alcohol component (A4) consisting of a perfluoroalkyl alcohol having terminal methylene groups (hydrocarbon spacers), of the general formula
   CF₃—(CF₂)ₓ—(CH₂)_{y}—OH
   with x=3-20 and y=1-6
or of a hexafluoropropene oxide (HFPO) oligomer alcohol of the general formula
   CF₃CF₂CF₂O—CF(CF₃)CF₂O)_{z}—CF(CF₃)CH₂—OH
   with z=1-10
or else mixtures of these having a hydroxyl group that is reactive toward isocyanate groups and having a molecular mass of 250 to 5000 daltons, with a polyisocyanate component (B)(ii) consisting of at least one diisocyanate, polyisocyanate, polyisocyanate derivative or polyisocyanate homolog having two or more (cyclo)aliphatic or aromatic isocyanate groups of same or different reactivity, in the presence if desired of a solvent component (L)(ii) and in the presence if desired of a catalyst,
c₂) if desired, reacting the preadduct from stage c₁) completely with a functionalizing component (C)(ii) having two or more amino and/or hydroxyl groups that are reactive toward isocyanate groups and having a molecular mass of 50 to 500 daltons, selected from the group of (cyclo)aliphatic and/or aromatic polyols and/or polyamines and/or polyamino alcohols.

Within the bounds of the present invention it is also possible to use, as the fluorine-modified macromonomer (A1), optionally solvent-containing reaction products of
i) perfluoroalkylalkenes and diethanolamine, preferably with perfluoroalkylalkenes having terminal methylene groups (hydrocarbon spacers), of the general formula
   CF₃—(CF₂)ₓ—CH═CH₂
   with x=3-20
and/or
ii) alkyl (per)fluoro(meth)acrylates and/or (per)fluoroalkyl (meth)acrylates and/or (per)fluoroalkyl (per)fluoro(meth)acrylates and diethanolamine and/or
iii) (per)fluoroalkylalkylene oxides and N-methylethanolamine or diethanolamine with preferred (per)fluoroalkylalkylene oxides of the general formula
   CF₃—(CF₂)ₓ—CH₂—C₂H₃O
   with x=3-20.

As the fluorine-modified macromonomer (A1) it is preferred to use reaction products and/or macromonomers, with a monomodal molar mass distribution, of monofunctional perfluoroalkyl alcohols, isophorone diisocyanate or toluene diisocyanate, and diethanolamine.

The higher molecular mass polyol component (A2) is composed of a polymeric polyol having two or more hydroxyl groups that are reactive toward isocyanate groups and having an average molecular mass (number average) of 500 to 6000 daltons. Suitable polymeric polyols which can be used include, for example, (hydrophobically modified) polyalkylene glycols, aliphatic or aromatic polyesters, polycaprolactones, polycarbonates, hydroxy-functional macromonomers and telecheles such as α,ω-polymethacrylatediols, α,ω-dihydroxyalkylpolydimethylsiloxanes, hydroxy-functional epoxy resins, hydroxy-functional ketone resins, hydroxy-functional polysulfides, hydroxy-functional triglycerides, oxidatively drying alkyd resins based on bisepoxides and unsaturated fatty acids, or suitable mixtures thereof. Preference is given to using linear and/or difunctional (hydrophobically modified) polyether- and/or polyester- and/or polycaprolactone- and/or polycarbonate-polyols and/or α,ω-polymethacrylatediols having a molecular mass of 500 to 3000 daltons.

The low molecular mass polyol components (A3)(i) and (A3)(ii) are composed of a polyol having two or more hydroxyl groups that are reactive toward polyisocyanates and having an average molecular mass of 50 to 499 daltons. Suitable low molecular mass polyols which can be used include, for example, 1,2-ethanediol or ethylene glycol, 1,2-propanediol or 1,2-propylene glycol, 1,3-propanediol or 1,3-propylene glycol, 1,4-butanediol or 1,4-butylene glycol, 1,6-hexanediol or 1,6-hexamethylene glycol, 2-methyl-1,3-propanediol, 2,2-dimethyl-1,3-propanediol or neopentyl glycol, 1,4-bis(hydroxymethyl)cyclohexane or cyclohexanedimethanol, 1,2,3-propanetriol or glycerol, 2-hydroxymethyl-2-methyl-1,3-propanol or trimethylolethane, 2-ethyl-2-hydroxymethyl-1,3-propanediol or trimethylolpropane, and 2,2-bis(hydroxymethyl)-1,3-propanediol or pentaerythritol.

The fluoro alcohol component (A4) is composed of a perfluoroalkyl alcohol having terminal methylene groups (hydrocarbon spacers), of the general formula
CF₃—(CF₂)ₓ—(CH₂)_{y}—OH
with x=3-20 and y=1-6
   or commercially customary mixtures (e.g., Zonyl® BA, BA L, BA LD, Du Pont de Nemours) or of a hexafluoropropene oxide (HFPO) oligomer alcohol of the general formula
   CF₃CF₂CF₂O—CF(CF₃)CF₂O)ₓ—CF(CF₃)CH₂—OH,
with z=1-10
   or commercially customary mixtures (e.g. Krytox®, Du Pont de Nemours), or mixtures of both.

As suitable perfluoroalkyl alcohols it is possible, moreover, to use 2,2-bis(trifluoromethyl)propanol, 1H,1H-2,5-di(trifluoromethyl)-3,6-dioxaundecafluorononanol, 1H,1H,7H-dodecafluoroheptanol, 2,2,3,3,4,4,5,5,6,6,7,7-dodecafluoro-1,8-octanediol, 1H,1H-heptafluorobutanol, 1H,1H,9H-hexadecafluorononanol, 1H,1H,3H-hexafluorobutanol, 2H-hexafluoro-2-propanol, 2,2,3,3,4,4,5,5-octafluoro-1,6-hexanediol, 1H,1H,5H-octafluoropentanol, 1H,1H-pentafluoropropanol, 2-(perfluorobutyl)ethanol, 3-(perfluorobutyl)propanol, 6-(perfluorobutyl)hexanol, 1H,1H-perfluoro-1-decanol, 2-(perfluorodecyl)ethanol, 6-(perfluoroethyl)hexanol, 2-(perfluorohexyl)ethanol, 6-(perfluorohexyl)hexanol, 3-(perfluorohexyl)propanol, 1H,1H-perfluoro-1-nonanol, 1H,1H-perfluoro-1-octanol, 2-(perfluorooctyl)ethanol, 6-(perfluorooctyl)hexanol, 3-(perfluorooctyl)propanol, 2-(perfluoro-3-methylbutyl)ethanol, 6-(perfluoro-1-methylethyl)hexanol, 2-(perfluoro-5-methylhexyl)ethanol, 2-(perfluoro-7-methyloctyl)ethanol, 2-perfluoropropoxy-2,3,3,3-tetrafluoropropanol, 1H,1H,3H-tetrafluoropropanol, 1,1,2,2-tetrahydroperfluoro-1-hexadecanol, 1,1,2,2-tetrahydroperfluoro-1-tetradecanol, and 1H,1H-trifluoroethanol.

The polyisocyanate components (B)(i), (B)(ii) and/or (B)(iii) are composed of at least one polyisocyanate, polyisocyanate derivative or polyisocyanate homolog having two or more aliphatic or aromatic isocyanate groups of same or different reactivity. Particularly suitable are the polyisocyanates that are well known in polyurethane chemistry, or combinations thereof. As suitable aliphatic polyisocyanates use may be made, for example, of 1,6-diisocyanatohexane (HDI), 1-isocyanato-5-isocyanatomethyl-3,3,5-trimethylcyclohexane or isophorone diisocyanate (IPDI), bis(4-isocyanatocyclohexyl)methane (H₁₂MDI), 1,3-bis(1-isocyanato-1-methylethyl)benzene (m-TMXDI) or technical isomer mixtures of the individual aromatic polyisocyanates. As suitable aromatic polyisocyanates use may be made, for example, of 2,4-diisocyanatotoluene or toluene diisocyanate (TDI), bis(4-isocyanatophenyl)methane (MDI) and, optionally, its higher homologs (polymeric MDI) or technical isomer mixtures of the individual aromatic polyisocyanates. Also suitable in principle, furthermore, are the “paint polyisocyanates” based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI). The term “paint polyisocyanates” denotes allophanate, biuret, carbodiimide, isocyanurate, uretdione and/or urethane group-containing derivatives of these diisocyanates, in which the residual monomeric diisocyanate content has been reduced to a minimum in accordance with the prior art. In addition it is also possible as well to use modified polyisocyanates, which are obtainable, for example, by hydrophilic modification of “paint polyisocyanates” based on 1,6-diisocyanatohexane (HDI). Likewise suitable are difunctional polyisocyanate derivatives and/or reaction products of at least trifunctional aliphatic or aromatic polyisocyanates and (optionally fluorine-modified) amino-functional polyhedral oligomeric polysilsesquioxanes (POSS) of the general formula (RSiO_{1.5})ₙ with n=4, 6, 8, 10, 12 and R=any organic residue having 1 to 100 C atoms and 0 to 50 N and/or 0 to 50 O and/or 0 to 50 F and/or 0 to 50 Si and/or 0 to 50 S atoms.

Silsesquioxanes are oligomeric or polymeric substances whose completely condensed representatives possess the general formula (SiO_{3/2}R)n, with n being >4 and it being possible for the residue R to be a hydrogen atom, though it usually denotes an organic residue. The smallest structure of a silsesquioxane is the tetrahedron. Voronkov and Lavrent'yev (Top. Curr. Chem. 102 (1982), 199-236) describe the synthesis of completely condensed and incompletely condensed oligomeric silsesquioxanes by hydrolytic condensation of trifunctional RSiY₃ precursors, R being a hydrocarbon residue and Y being a hydrolyzable group, such as chloride, alkoxide or siloxide. Lichtenhan et al. describe the base-catalyzed preparation of oligomeric silsesquioxanes (WO 01/10871). Silsesquioxanes of the formula R₈Si₈O₁₂ (with like or different hydrocarbon residues R) can be reacted with base catalysis to give functionalized, incompletely condensed silsesquioxanes, such as R₇Si₇O₉(OH)₃ or else R₈Si₈O₁₁(OH)₂ and R₈Si₈O₁₀(OH)₄ (Chem. Commun. (1999), 2309-10; Polym. Mater. Sci. Eng. 82 (2000), 301-2; WO 01/10871) and so may serve as a parent compound for a multiplicity of different incompletely condensed and functionalized silsesquioxanes. In particular, the silsesquioxanes (trisilanols) of the formula R₇Si₇O₉(OH)₃ can be converted by reaction with functionalized, monomeric silanes (corner capping) into oligomeric silsesquioxanes modified accordingly.

With regard to component (B)(i), 2,4-toluene diisocyanate or technical isomer mixtures of 2,4-toluene diisocyanate and 2,6-toluene diisocyanate, or technical cis/trans isomer mixtures of isophorone diisocyanate (IPDI), are preferred. Particular preference is given to polyisocyanates having isocyanate groups of different reactivity.

In the case of component (B)(ii), 2,4-toluene diisocyanate or technical isomer mixtures of 2,4-toluene diisocyanate and 2,6-toluene diisocyanate or bis(4-isocyanatophenyl)methane (MDI) and optionally its higher homologs (polymeric MDI) and/or technical isomer mixtures or technical cis/trans isomer mixtures of isophorone diisocyanate (IPDI) are preferred.

In the case of component (B)(iii), 2,4-toluene diisocyanate or technical isomer mixtures of 2,4-toluene diisocyanate and 2,6-toluene diisocyanate or bis(4-isocyanatophenyl)methane (MDI) and optionally its higher homologs (polymeric MDI) and/or technical isomer mixtures or technical cis/trans isomer mixtures of isophorone diisocyanate (IPDI) or “paint polyisocyanates” based on 1,6-diisocyanatohexane (HDI) are regarded as preferred.

The optionally fluorine-modified functionalizing component (C)(i) is composed of compounds having one or more amino and/or hydroxyl groups that are reactive toward polyisocyanates and/or one or more isocyanato groups that are reactive toward hydroxyl groups and having a molecular mass of 50 to 2500 daltons, selected from the groups of (cyclo)aliphatic and/or aromatic polyols and/or polyamines and/or polyamino alcohols and/or reactive polyhedral oligomeric polysilsesquioxanes (POSS) of the general formula (RSiO_{1.5})ₙ with n=4, 6, 8, 10, 12 and R=any organic residue having 1 to 100 C atoms and 0 to 50 N and/or 0 to 50 O and/or 0 to 50 F and/or 0 to 50 Si and/or 0 to 50 S atoms and a molar mass of 250 to 25 000 daltons. Suitable compounds which can be used include, for example, monoalcohols, monoamines, ethanolamine, diethanolamine, ethylenediamine, diethylenetriamine, N-(2-aminoethyl)-2-aminoethanol, trimethylolpropane, polyisocyanate components analogous to (B)(i), (B)(ii), and (B)(iii), and reactive polyhedral oligomeric polysilsesquioxanes (POSS) of the general formula (RSiO_{1.5})₈ with R=aminopropyl and/or isocyanatopropyl and optionally CH₂CH₂CF₂CF₂CF₂CF₂CF₂CF₃ and/or H and/or alkyl and/or cycloalkyl and/or aryl and/or (CH₂)₃(OCH₂CH₂)ₙOMe and/or epoxypropyl and/or dimethoxysilyloxy and/or methacryloyloxypropyl and/or triethoxysilylpropyl.

Within the bounds of the present invention, however, it is also possible to use, as component (C)(i), reactive polyhedral oligomeric polysilsesquioxanes (POSS) of the general formula
(RₐX_{b}SiO_{1.5})ₘ
with a=0 or 1, b=0 or 1, a+b=1, m=2, 6, 8, 10, 12, and with R=hydrogen atom, alkyl, cycloalkyl, alkenyl, cycloalkenyl, alkynyl or cycloalkynyl group or polymer unit, which in each case is substituted or unsubstituted, or further functionalized polyhedral oligomeric silicon-oxygen cluster units, which are attached via a polymer unit or a bridging unit, X=oxy, hydroxy, alkoxy, carboxy, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine or polyether group or substituents of type R that contain at least one such group of type X, the substituents of type R being identical or different and the substituents of type X being identical or different.

The functionalizing component (C)(i) may be composed, furthermore, of compounds and having two or more amino and/or hydroxyl groups that are reactive toward isocyanate groups and having a molecular mass of 50 to 500 daltons, selected from the groups of (cyclo)aliphatic and/or aromatic polyols and/or polyamines and/or polyamino alcohols. Suitable compounds which can be used include, for example, ethanolamine, diethanolamine, ethylenediamine, diethylenetriamine, N-(2-aminoethyl)-2-aminoethanol, and trimethylolpropane. Diethanolamine is used with preference.

The low molecular mass polyamine component (E) is composed of a polyamine having two or more (cyclo)aliphatic or aromatic amino groups that are reactive toward polyisocyanates and having a molecular mass of 50 to 500 daltons. Suitable (cyclo)aliphatic polyamines which can be used include, for example, adipic dihydrazide, ethylenediamine, diethylenetriamine, triethylenetetramine, tetraethylenepentamine, pentaethylenehexamine, dipropylenetriamine, hexamethylenediamine, hydrazine, isophoronediamine, N-(2-aminoethyl)-2-aminoethanol, Jeffamines® (polyoxyalkyleneamines) from Huntsman Corporation, diaspartic esters, adducts of salts of 2-acrylamido-2-methylpropane-1-sulfonic acid (AMPS) and ethylenediamine, adducts of salts of (meth)acrylic acid and ethylenediamine, adducts of 1,3-propane sulfone and ethylenediamine, or any desired mixtures thereof. Suitable aromatic polyamines which can be used include, for example bis(4-amino-3-methylphenyl)methane, cumenediamine, 3,3′-dichloro-4,4′-diaminodiphenylmethane (MOCA), diethyltoluenediamine, methylenedianiline (MDA), m-phenylenediamine (m-PDA) or any desired mixtures thereof. In addition it is also possible to use latent curing agents based on aldimines and/or ketimines and/or enamines, which on ingress of water (e.g., atmospheric moisture) re-release the polyamines, with or without release of volatile elimination products.

The solvent components (L)(i), (L)(ii) and (L)(iii) are composed of low-boiling or high-boiling organic solvents. Suitable solvents which can be used include, for example, N-methylpyrrolidone, glycol ethers such as dipropylene glycol dimethyl ether (Proglyde DMM®), cyclic alkylene carbonates, xylene, ethylbenzene, C3-alkylbenzene (cumene), ethyl acetate, butyl acetate, butyl glycol, 1.methoxypropyl acetate, and methyl isobutyl ketone. Fluorine-modified one- or two-component polyurethane resins preferably contain less than 10% by weight of organic solvents in the system as a whole.

The formulating components (F)(i) and (F)(ii) comprise, for example, defoamers, devolatilizers, lubricity and flow-control additives, dispersing additives, substrate wetting additives, water repellents, rheology additives, coalescence assistants, matting agents, adhesion promoters, antifreeze agents, antioxidants, UV stabilizers, bactericides, fungicides, further polymers and/or polymer dispersions, fillers, pigments, and nanoparticles of all kinds, or suitable combinations thereof, with the individual formulating constituents necessarily being regarded as inert. The formulating constituents can be introduced both during and after the preparation of the fluorine-modified one- or two-component polyurethane resins.

The solids content of fluorine-modified polyurethane prepolymer or polyol mixture, consisting of components (A1), (A2), (A3)(i), (B)(i), and (C)(i), in stage a) is set at 25% to 100% by weight, preferably 50% to 75% by weight, based on the total amount of the binder, consisting of components (A1), (A2), (A3)(i), (B)(i), optionally (C)(i), (F)(i), optionally (L)(i) and optionally (L)(iii).

The solids content of crosslinker component, consisting of components (B)(iii) and (B)(iii) or (A3)(ii) and/or (E), respectively, in stage c) is set at 25% to 100% by weight, preferably 50% to 75% by weight, based on the total amount of curing agent (D), consisting of components (B)(iii) or (A4)(ii) and/or (E), (F)(ii) and optionally (L)(iii).

The polyurethane polymer, consisting of components (A), (B), (C), and (E), has a preferred average molecular mass (number average) of 10 000 to 100 000 daltons.

The present invention further relates to a process for preparing fluorine-modified one- or two-component polyurethane resins by preparing a fluorine-modified polyurethane prepolymer or a fluorine-modified polyol mixture (binder) in stage a) and the subsequent preparation of the fluorine-modified polyurethane resin in stage b). This process is implemented, employing the techniques which are customary in polyurethane chemistry in the reaction stage, by preparing a fluorine-modified polyurethane prepolymer or polyol mixture (binder) by reacting in reaction stage a₁) components (A1), (A2), and (A3)(i) either with component (B)(i) in the presence if desired of a solvent component (L)(i) and in the presence if desired of a catalyst, some or all of the hydroxyl groups of components (A1), (A2), and (A3)(i) being reacted with the isocyanate groups of component (B)(i), or blending said components in the presence if desired of a solvent component (L)(i) and in the presence if desired of a catalyst, reacting, if desired, the fluorine-modified polyurethane prepolymer or the polyol mixture from stage a₁) additionally, in reaction stage a₂), with an optionally fluorine-modified functionalizing component (C)(i), and, in reaction stage a₃), admixing the fluorine-modified polyurethane prepolymer or polyol mixture from stages a₁) or a₂) with a formulating component (F)(i), the formulating constituents being added individually or together before, during or after the reaction or blending of the individual components.

The fluorine-modified macromonomer (A1) is preferably prepared by reacting in reaction stage c₁) a fluoro alcohol component (A4) with the polyisocyanate component (B)(ii) in the presence if desired of a solvent component (L)(ii) and in the presence if desired of a catalyst, the reaction conditions and the selectivities of components (A4) and (B)(ii) being chosen such that only one isocyanate group of component (B)(ii) reacts with component (A4), and subsequently if desired, in reaction stage c₂), reacting the uniform preadduct from stage c₁) completely with the functionalizing component (C)(ii), the reaction conditions and the selectivity of component (C)(ii) being chosen so that only one reactive group of component (C)(ii) reacts with the free isocyanate group(s) of the preadduct.

According to one preferred embodiment in this case the fluoro alcohol component (A4) is added dropwise within a period of 30 to 60 minutes at a temperature between −20 and 50° C. with the addition if desired of a suitable solvent (L)(ii) and with the addition if desired of a catalyst to the polyisocyanate component (B)(ii) and is reacted in such a way that only one isocyanate group is reacted. In a further, optional step the resultant preadduct is introduced dropwise within a few minutes into the functionalizing component (C)(ii), with cooling. Suitable solvents (L)(ii) are, for example, N-methylpyrrolidone (NMP) or tetrahydrofuran.

In the subsequent reaction stage b), finally, a fluorine-modified polyurethane resin is prepared by reacting the fluorine-modified polyurethane prepolymer from stage b₃) in the case of a one-component application with atmospheric moisture, or reacting the fluorine-modified polyurethane prepolymer or polyol mixture from stage b₃) (binder) in the case of a two-component application with a crosslinker component (D) (curing agent), consisting of a polyisocyanate component (B)(iii) or a low molecular mass polyol component (A4)(ii) and/or a low molecular mass polyamine component (E), a formulating component (F)(ii), and, if desired, a solvent component (L)(iii), in the presence if desired of a catalyst, the formulating constituents being added individually or together before, during or after the blending of the individual components.

The NCO/OH equivalent ratio of components (A1), (A2), (A3)(i), and (B)(i) in stage a) is set preferably at a level of 0.5 to 10.0, preferably 1.5 to 6.0.

The NCO/OH equivalent ratio of binder and curing agent in stage b) is set at a preferred level of 1.0 to 2.0, preferably 1.0 to 1.5.

The NCO/OH equivalent ratio of components (A4) and (B)(ii) in stage c₁) is set in particular at 1.9 to 2.1 and the NCO/OH+NH equivalent ratio of the components in the preadduct from stage c₁) and (C)(ii) in stage c₂) is set at 0.95 to 1.05.

Reaction stages a), b), and c) are usually carried out in the presence of 0.01% to 1% by weight, based on components (A) and (B), of a catalyst which is customary for polyaddition reactions with polyisocyanates. Examples of customary catalysts for polyaddition reactions with polyisocyanates are dibutyltin oxide, dibutyltin dilaurate (DBTL), triethylamine, tin(II) octoate, 1,4-diazabicyclo[2.2.2]octane (DABCO), 1,4-diazabicyclo[3.2.0]-5-nonene (DBN), and 1,5-diazabicyclo[5.4.0]-7-undecene (DBU).

Reaction stages a₁) and a₂) are carried out preferably at a temperature of 40 to 120° C., in particular at 50 to 110° C.

Reaction stages c₁) and c₂) are carried out preferably at a temperature of −20 to 50° C., in particular at 0 to 30° C.

Reaction stages a₃) and b) are carried out preferably at a temperature of 10 to 60° C., in particular at 20 to 50° C.

The present invention further relates to the use of fluorine-modified one- or two-component polyurethane resins having improved surface properties in the construction or industrial sector for the permanent oil- and water-repellent surface treatment or modification of mineral and nonmineral substrates, such as
a) Inorganic surfaces,
   such as porous, absorbent, rough, and polished construction materials and building materials of all kinds (such as concrete, gypsum, silica and silicates, artificial stone, and natural stone (such as granite, marble, sandstone, slate, and serpentine), clay, cement, brick) and also enamels, fillers and pigments, glass, ceramic, metals and metal alloys,
b) Organic surfaces,
   such as wood and woodbase materials, wood veneer, glass fiber-reinforced plastics (GRP), plastics, leather, natural fibers, polar organic polymers of all kinds, and composite materials.

The fluorine-modified one-component or two-component polyurethane resins proposed in accordance with the invention, having improved surface properties, are suitable for permanent oil- and water-repellent surface treatment or modification in the application sectors of
construction, such as
   antigraffiti/antisoiling coatings
   easy to clean coatings
   further coatings of all kinds (such as balcony coatings, roof (tile) coatings, baking varnishes, paints and varnishes, masonry paints, floor coatings, light-, medium- and heavy-duty industrial floors, carpark surfacings, sports floors)
   seals
   prefabricated concrete components
   concrete moldings
   tiles and joints
   adhesives and sealants
   soundproofing walls
   corrosion control
   renders and decorative plasters
   external insulation and finishing systems (EIFS) and external insulation systems (EIS)
      and also
non-construction and industry, such as
   automobile industry
   coil coatings
   baking varnishes
   glass facades and glass surfaces
   ceramics, including sanitary ceramics
   leather dressing
   surface-modified fillers and pigments
   paper coating
   rotors of wind turbines
   marine paints.

In addition the fluorine-modified one- or two-component polyurethane resins proposed in accordance with the invention, having improved surface properties, are suitable for use in the construction sector for the integral water/oil repellency treatment of concrete, such as
prefabricated concrete components
concrete moldings
cast-in-place concrete
shotcrete
ready-mix concrete.

Depending on the field of application and the associated profile of requirements, therefore, the fluorine-modified one- or two-component polyurethane resins of the invention can be used in order to prepare
one-component, prepolymer-based systems curable with atmospheric moisture, or
one-component, prepolymer-based systems curable by way of latent curing agents, or
two-component, prepolymer-based systems curable with crosslinkers, or
two-component, polyol-based systems curable with crosslinkers.

Through an appropriate choice and quantity of the described fluorine components it is possible to obtain coating systems and/or surfaces having very low critical surface tensions and very high contact angles, which exhibit excellent antigraffiti and antisoiling properties.

Particularly for applications where very high chemical resistance and solvent resistance are called for, the fluorine-modified one- or two-component polyurethane resins of the invention are superior to aqueous binder systems with fluorine modification.

The fluorine-modified one- or two-component polyurethane resins of the invention, having improved surface properties, can be used for the respective fields of application in principle both in formulated form and in unformulated form. Formulation takes place in accordance with the techniques and methods that are known from the technology of paints and coatings.

It is in principle also possible, within formulations, to combine the fluorine-modified one- or two-component polyurethane resins of the invention, having improved surface properties, with aqueous or nonaqueous binders and/or to combine formulations based on the fluorine-modified one- or two-component polyurethane resins having improved surface properties with formulations based on aqueous or nonaqueous binders. The term “aqueous or nonaqueous binders” here denotes water-based polyurethanes, polymer dispersions, redispersible polymer powders or nonaqueous solvent-containing or solvent-free and optionally reactive polymers.

The fluorine-modified one- or two-component polyurethane resins of the invention, having improved surface properties, are applied by the known methods, such as flowcoating, casting, knifecoating, rolling, spraying, brushing, dipping or rollercoating.

The coatings produced from the fluorine-modified one- or two-component polyurethane resins of the invention, having improved surface properties, are dried and cured generally at normal (exterior and interior) temperatures in the range from 5 to 50° C., i.e., without specific heating of the coatings, but depending on application can also be dried and cured, alternatively, at higher temperatures in the range from 50 to 150° C.

The examples which follow are intended to illustrate the invention in more detail.

### EXAMPLES

### Example 1

### Fluorine-Modified Diol Component (T-Bone)

A four-neck flask equipped with dropping funnel, KPG stirrer, reflux condenser, internal thermometer, and nitrogen blanketing was charged with 0.1 mol of 2,4-toluene diisocyanate (TDI) (Desmodur T 80, Bayer AG) in solution in 28.8 g of N-methylpyrrolidone (NMP), with nitrogen blanketing, and this initial charge was cooled to about 15-20° C. Crystallization of 2,4-tolylene diisocyanate (TDI) ought absolutely to be avoided. Following the addition of two drops of dibutyltin dilaurate (DBTL) as catalyst, an equimolar amount of fluoro alcohol (e.g., Zonyl® BA, Du Pont de Nemours) was slowly added dropwise over the course of about 1 hour, with cooling. After the end of the dropwise addition the batch was stirred at the same temperature for an hour until the desired NCO value was reached. The preadduct was subsequently added slowly dropwise, with cooling, to an equimolar amount of diethanolamine (DEA), mixed with 3.0 g of N-methylpyrrolidone (NMP). The reaction is at an end when the NCO value has fallen to zero.

### Example 2

### Fluorine-Modified Lightfast 1K Polyurethane Sealant for Floors (Moisture-Curing)

In a four-neck flask equipped with KPG stirrer, reflux condenser, thermometer, and nitrogen blanketing a mixture of 4.7 parts by weight of fluorine-modified diol component (see example 1, containing 1.4 parts by weight of N-methylpyrrolidone (NMP)) and 25.2 parts by weight of isophorone diisocyanate (Vestanat® IPDI, Degussa AG) was stirred at 80-90° C. for 2 h under nitrogen blanketing in the presence of 1 drop of dibutyltin dilaurate (DBTL) as catalyst. Following the addition of 41.5 parts by weight of Desmophen C 200 with a hydroxyl number of 56 mg KOH·g⁻¹ (Bayer AG) the mixture was stirred further under nitrogen blanketing at 80-90° C. until the calculated NCO content was reached (theory: 10.37% by weight). The progress of the reaction was monitored by acidimetry. Subsequently 28.6 parts by weight of Proglyde® DMM (Dow Chemical) are added.

Fluorine content (based on binder): 2.0% by weight

### Example 3

### Fluorine-Modified 2K Polyurethane Floor Coating, Self-Leveling, Low-Solvent

Filled Polyol Component (Part A):

In a vacuum dissolver a mixture of 30.6 parts by weight of Sovermol® 805 (Cognis Deutschland GmbH) and 13.5 parts by weight of fluorine-modified diol component (see example 1, containing 4.0 parts by weight of N-methylpyrrolidone (NMP)) was admixed slowly, with continual stirring, with 4.4 parts by weight of zeolite paste (Finma Chemie), 1.0 part by weight of Perenol E 8 (Cognis Deutschland GmbH), 0.5 part by weight of Perenol F 40 (Cognis Deutschland GmbH), 8.0 parts by weight of Micro Talc AT 1 (Norwegian-Talc), 17 parts by weight of Baryte C 14 (Sachtleben), 5.0 parts by weight of pigment powder (Heucosin grades from Heubach) and 20.0 parts by weight of Millisil W12 (Quarzwerke). This mixture was subsequently dispersed under vacuum at 1500 rpm for about 20 minutes.

Polyisocyanate (Part B):

15.75 parts by weight of Desmodur VL R 10 (polymeric MDI, Bayer AG, isocyanate content: 31.5% by weight)

Mixing ratio of part A:part B=100:15.75

Fluorine content (based on the formulation): 3.6% by weight

### Example 4

### Fluorine-Modified 2K Polyurethane Floor Coating, Self-Leveling, Low-Solvent

Filled Polyol Component (Part A):

In a vacuum dissolver a mixture of 16.5 parts by weight of Desmophen® 1145 (Bayer AG), 17.6 parts by weight of Desmophen® 1150 (Bayer AG) and 13.3 parts by weight of fluorine-modified diol component (see example 1, containing 4.0 parts by weight of N-methylpyrrolidone (NMP)) was admixed slowly, with continual stirring, with 7.8 parts by weight of FinmaSorb 430 PR (Finma Chemie), 0.5 part by weight of Texaphor P 61 (Cognis Deutschland GmbH), 41.2 parts by weight of Quarzmehl W 6 (Quarzwerke), 2.6 parts by weight of pigment powder and 0.5 part by weight of Perenol E 8 (Cognis Deutschland GmbH). This mixture was subsequently dispersed under vacuum at 1500 rpm for about 20 minutes.

Polyisocyanate (Part B):

22.0 parts by weight of Desmodur VL (polymeric MDI, Bayer AG, isocyanate content: 31.5% by weight)

Mixing ratio of part A:part B=100:22

Fluorine content (based on the formulation): 3.4% by weight

### Example 5

### Lightfast 1K Polyurethane Sealant for Floors (Moisture-Curing, Fluorine- and Polysilsesquioxane-Modified)

In a four-neck flask equipped with KPG stirrer, reflux condenser, thermometer, and nitrogen blanketing a mixture of 5.0 parts by weight of fluorine-modified diol component (see example 1, containing 1.5 parts by weight of N-methylpyrrolidone (NMP)) and 26.3 parts by weight of isophorone diisocyanate (Vestanat® IPDI, Degussa AG) was stirred at 80-90° C. for 2 h under nitrogen blanketing in the presence of about 1 drop of dibutyltin dilaurate (DBTL) as catalyst. Following the addition of 34.7 parts by weight of Desmophen C 200 with a hydroxyl number of 56 mg KOH·g⁻¹ (Bayer AG) and 4.4 parts by weight of α,ω-polymethacrylatediol (Tego Chemie Service GmbH) and also 1.1 parts by weight of 3-{3,5,7,9,11,13,15-heptaisobutylpentacyclo[9.5.1.1-(3,9).1(5,15).1(7,13)]octasiloxan-1-yl}propyl isocyanate (Degussa AG) the mixture was stirred further under nitrogen blanketing at 80-90° C. until the calculated NCO content was reached (theory: 10.86% by weight). The progress of the reaction was monitored by acidimetry. Subsequently 28.5 parts by weight of Proglyde® DMM (Dow Chemical) are added.

Fluorine content (based on binder): 2.2% by weight

Overview of Components

Stage a): Fluorine-Modified Macromonomer (A1)

(A4) fluoro alcohol component
(B)(ii) polyisocyanate component II
(C)(ii) functionalizing component II
(L)(ii) solvent component III
   Stage b): Fluorine-Modified Polyurethane Prepolymer or Polyol Mixture
(A1) fluorine-modified macromonomer from stage a)
(A2) higher molecular mass polyol component
(A3)(i) low molecular mass polyol component I
(B)(i) polyisocyanate component I
(C)(i) functionalizing component I
(F)(i) formulating component I
(L)(i) solvent component I
   Stage c): Fluorine-Modified Polyurethane Resin
(D) crosslinker component (mixture), comprising
(B)(iii) polyisocyanate component III
(A3)(ii) low molecular mass polyol component II
(E) low molecular mass polyamine component
(F)(ii) formulating component II
(L)(iii) solvent component I

1-29. (canceled)

30. A fluorine-modified one- or two-component polyurethane resin, prepared by the process of
a) preparing a fluorine-modified polyurethane prepolymer having free isocyanate groups or free amino and/or hydroxyl groups, or a fluorine-modified polyol mixture having free hydroxyl groups (binder), by
a₁) a fluorine-modified macromonomer (A1) having two or more amino and/or hydroxyl groups that are reactive toward isocyanate groups and having a molecular mass of 500 to 2000 daltons, a higher molecular mass polyol component (A2) having two or more hydroxyl groups that are reactive toward isocyanate groups and having a molecular mass of 500 to 6000 daltons, and, optionally, a low molecular mass polyol component (A3)(i) having two or more hydroxyl groups that are reactive toward isocyanate groups and having a molecular mass of 50 to 499 daltons
either
is reacted with a polyisocyanate component (B)(i), consisting of at least one diisocyanate, polyisocyanate, polyisocyanate derivative or polyisocyanate homolog having two or more (cyclo)aliphatic or aromatic isocyanate groups of same or different reactivity, optionally in the presence of a solvent component (L)(i) and optionally in the presence of a catalyst,
or
is blended in the presence of a solvent component (L)(i) and optionally in the presence of a catalyst,
a₂) the fluorine-modified polyurethane prepolymer or polyol mixture from stage a₁) is optionally reacted with an unmodified or fluorine-modified functionalizing component (C)(i) having one or more amino and/or hydroxyl groups that are reactive toward isocyanate groups and/or one or more isocyanate groups that are reactive toward hydroxyl groups and having a molecular mass of 50 to 2500 daltons, selected from the groups of the (cyclo)aliphatic and/or aromatic polyols and/or polyamines and/or polyamino alcohols and/or reactive polyhedral oligomeric polysilsesquioxanes (POSS) of the general formula (RSiO_{1.5})ₙ with n=4, 6, 8, 10, 12 and R=any organic residue having 1 to 100 C atoms and 0 to 50 N and/or 0 to 50 O and/or 0 to 50 F and/or 0 to 50 Si and/or 0 to 50 S atoms and a molar mass of 250 to 25 000 daltons,
a₃) the fluorine-modified polyurethane prepolymer or polyol mixture from stages a₁) or a₂) is admixed with a formulating component (F)(i),
and finally
b) by preparing a fluorine-modified polyurethane resin having a polymer-bonded fluorine content of 1% to 4% by weight in the system as a whole by reacting the fluorine-modified polyurethane prepolymer from stage a₃) in the case of a one-component application with atmospheric moisture, or reacting the fluorine-modified polyurethane prepolymer or polyol mixture from stage a₃) (binder) in the case of a two-component application with a crosslinker component (D) (curing agent), with a formulating component (F)(ii) optionally in the presence of a solvent component (L)(iii) and also of a catalyst, using as crosslinker component (D) in the case of the polyol mixture from stage a₃) a polyisocyanate component (B)(iii) consisting of at least one diisocyanate, polyisocyanate, polyisocyanate derivative or polyisocyanate homolog having two or more (cyclo)aliphatic or aromatic isocyanate groups of same or different reactivity and in the case of the polyurethane prepolymer a polyisocyanate component (B)(iii) or a low molecular mass polyol component (A3)(ii) having two or more hydroxyl groups that are reactive toward isocyanate groups and having a molecular mass of 50 to 499 daltons and/or a low molecular mass polyamine component (E) having two or more (cyclo)aliphatic or aromatic amino groups that are reactive toward isocyanate groups and having a molecular mass of 50 to 500 daltons.

31. The fluorine-modified polyurethane resin of claim 30, wherein the fluorine-modified macromonomer (A1) has been prepared by
c₁) reacting a fluoro alcohol component (A4) consisting of a perfluoroalkyl alcohol having terminal methylene groups (hydrocarbon spacers), of the general formula
CF₃—(CF₂)ₓ—(CH₂)_{y}—OH,
with x=3-20 and y=1-6
or of a hexafluoropropene oxide (HFPO) oligomer alcohol of the general formula
CF₃CF₂CF₂O—CF(CF₃)CF₂O)_{z}—CF(CF₃)CH₂—OH
with z=1-10
or else mixtures of these having a hydroxyl group that is reactive toward isocyanate groups and having a molecular mass of 250 to 5000 daltons, with a polyisocyanate component (B)(ii) consisting of at least one diisocyanate, polyisocyanate, polyisocyanate derivative or polyisocyanate homolog having two or more (cyclo)aliphatic or aromatic isocyanate groups of same or different reactivity, optionally in the presence of a solvent component (L)(ii) and optionally in the presence of a catalyst,
c₂) optionally reacting the preadduct from stage c₁) completely with a functionalizing component (C)(ii) having two or more amino and/or hydroxyl groups that are reactive toward isocyanate groups and having a molecular mass of 50 to 500 daltons, selected from the group of (cyclo)aliphatic and/or aromatic polyols and/or polyamines and/or polyamino alcohols.

32. The fluorine-modified polyurethane resin of claim 30, wherein the fluorine-modified macromonomer (A1) is a reaction product or macromonomer, with a monomodal molar mass distribution, of monofunctional perfluoroalkyl alcohols, isophorone diisocyanate or toluene diisocyanate, and diethanolamine.

33. The fluorine-modified polyurethane resin of claim 30, wherein as fluorine-modified macromonomer (A1) is an optionally solvent-containing reaction product of
i) perfluoroalkylalkenes and diethanolamine, preferably perfluoroalkylalkenes having terminal methylene groups (hydrocarbon spacers), of the general formula
CF₃—(CF₂)ₓ—CH═CH₂
with x=3-20
and/or
ii) alkyl (per)fluoro(meth)acrylates and/or (per)fluoroalkyl (meth)acrylates and/or (per)fluoroalkyl (per)fluoro(meth)acrylates and diethanolamine
or
(per)fluoroalkylalkylene oxides and N-methylethanolamine or diethanolamine with preferred (per)fluoroalkylalkylene oxides of the general formula
CF₃—(CF₂)ₓ—CH₂—C₂H₃O
with x=3-20.

34. The fluorine-modified polyurethane resin of claim 30, wherein the higher molecular mass polyol component (A2) is a (hydrophobically modified) polyalkylene glycol, an aliphatic or aromatic polyester, a polycaprolactone, a polycarbonate, a hydroxy-functional macromonomer or a telechele such as α,ω-polymethacrylatediols, α,ω-dihydroxyalkylpolydimethylsiloxanes, hydroxy-functional epoxy resins, hydroxy-functional ketone resins, hydroxy-functional polysulfides, hydroxy-functional triglycerides, oxidatively drying alkyd resins based on bisepoxides and unsaturated fatty acids, or mixtures thereof.

35. The fluorine-modified polyurethane resin of claim 30, wherein component (A2) is a linear or difunctional (hydrophobically modified) polyether- or polyester- or polycaprolactone- or polycarbonate-polyol or an α,ω-polymethacrylatediol having a molecular mass of 500 to 3,000 daltons.

36. The fluorine-modified polyurethane resin of claim 30, wherein component (A3)(i) and (A3)(ii) is at least one of 1,4-butanediol or 2-methyl-1,3-propanediol or 2,2-dimethyl-1,3-propanediol.

37. The fluorine-modified polyurethane resin of claim 30, wherein components (B)(i) and/or (B)(ii) and/or (B)(iii) are selected from difunctional polyisocyanate derivatives and/or reaction products of at least trifunctional aliphatic or aromatic polyisocyanates and optionally fluorine-modified amino-functional polyhedral oligomeric polysilsesquioxanes (POSS) of the general formula (RSiO_{1.5})ₙ with n=4, 6, 8, 10, 12 and R=any organic residue having 1 to 100 C atoms and 0 to 50 N and/or 0 to 50 O and/or 0 to 50 F and/or 0 to 50 Si and/or 0 to 50 S atoms.

38. The fluorine-modified polyurethane resin of claim 30, wherein component (C)(i) comprises reactive polyhedral oligomeric polysilsesquioxanes (POSS) of the general formula (RSiO_{1.5})₈ with R=aminopropyl and/or isocyanatopropyl and optionally CH₂CH₂CF₂CF₂CF₂CF₂CF₂CF₃ and/or H and/or C₁-C₂₅-alkyl and/or C₃-C₂₅-cycloalkyl and/or C₆-C₃₀-aryl and/or (CH₂)₃(OCH₂CH₂)ₙOMe and/or epoxypropyl and/or dimethoxysilyloxy and/or methacryloyloxypropyl and/or triethoxysilylpropyl.

39. The fluorine-modified polyurethane resin of claim 30, wherein component (C)(i) is a reactive polyhedral oligomeric polysilsesquioxanes (POSS) of the general formula
(RₐX_{b}SiO_{1.5})ₘ
with a=0 or 1
b=0 or 1
a+b=1
m=4, 6, 8, 10, 12,
and
R is a hydrogen atom, alkyl, cycloalkyl, alkenyl, cycloalkenyl, alkynyl or cycloalkynyl group or polymer unit, which in each case is substituted or unsubstituted, or further functionalized polyhedral oligomeric silicon-oxygen cluster units, which are attached via a polymer unit or a bridging unit,
X is oxy, hydroxy, alkoxy, carboxy, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine or polyether group or substituents of type R that contain at least one such group of type X,
the substituents of type R and the substituents of type X each being identical or different.

40. The fluorine-modified polyurethane resin of claim 30, wherein low molecular mass polyamine component (E) is an (cyclo)aliphatic and/or aromatic polyamine and/or amino alcohol.

41. The fluorine-modified polyurethane resin of claim 30, wherein the low molecular mass polyamine component (E) latent is a curing agent based on an aldimine and/or a ketimine and/or an enamine.

42. The fluorine-modified polyurethane resin of claim 30, wherein formulating component (F)(i) and (F)(ii) is a defoamer, a devolatilizer, lubricity and a flow-control additive, a dispersing additive, a substrate wetting additive, a water repellent, a rheology additive, a coalescence assistant, a matting agent, an adhesion promoter, an antifreeze agent, a antioxidant, a UV stabilizer, a bactericide, a fungicide, a further polymer, a filler, a pigment, or a nanoparticle, or a suitable combination thereof.

43. The fluorine-modified polyurethane resin of claim 30, wherein the NCO/OH equivalent ratio of components (A1), (A2), (A3)(i), and (B)(i) in stage a) is set at a level of 0.5 to 10.0.

44. The fluorine-modified polyurethane resin of claim 30, wherein the NCO/OH equivalent ratio of components (A4) and (B)(ii) in stage c₁) is set at 1.9 to 2.1 and the NCO/OH+NH equivalent ratio of the components in the preadduct from stage c₁) and (C)(ii) in stage c₂) is set at 0.95 to 1.05.

45. The fluorine-modified polyurethane resin of claim 30, wherein the NCO/OH equivalent ratio of binder and curing agent in stage b) is set at a level of 1.0 to 2.0.

46. The fluorine-modified polyurethane resin of claim 30, wherein reaction stages a), b), and c) are carried out in the presence of 0.01% to 1% by weight, based on components (A) and (B), of a catalyst which is customary for polyaddition reactions with polyisocyanates.

47. The fluorine-modified polyurethane resin of claim 30, wherein in stage a) the solids content of fluorine-modified polyurethane prepolymer or polyol mixture, consisting of components (A1), (A2), (A3)(i), (B)(i), and (C)(i), is set at 25% to 100% by weight based on the total amount of the binder, consisting of components (A1), (A2), (A3)(i), (B)(i), optionally (C)(i), (F)(i), optionally (L)(i) and optionally (L)(iii).

48. The fluorine-modified polyurethane resin of claim 47, wherein in stage a) the solids content of fluorine-modified polymethane prepolymer or polyol mixture is set at 50% to 75% by weight, based on the total amount of the binder.

49. The fluorine-modified polyurethane resin of claim 30, wherein in stage b) the solids content of crosslinker component, consisting of components (B)(iii) and (B)(iii) or (A3)(ii) and/or (E), respectively, is set at 25% to 100% by weight, based on the total amount of curing agent (D), consisting of components (B)(iii) or (A3)(ii) and/or (E), (F)(ii) and, optionally, (L)(iii).

50. The fluorine-modified polyurethane resin of claim 49, wherein in stage b) the solids content of crosslinker component is set at 50% to 75% by weight, based on the total amount of the curing agent (D).

51. The fluorine-modified polyurethane resin of claim 30, wherein the polyurethane polymer, consisting of components (A), (B), (C), and (E), has an average molecular mass (number average) of 10,000 to 100,000 daltons.

52. A process for preparing the fluorine-modified polyurethane resin of claim 30, wherein
a) a fluorine-modified polyurethane prepolymer or polyol mixture (binder) is prepared by
a₁) reacting components (A1), (A2), and (A3)(i) either with component (B)(i) optionally in the presence of a solvent component (L)(i) and optionally in the presence of a catalyst, some or all of the hydroxyl groups of components (A1), (A2), and (A3)(i) being reacted with the isocyanate groups of component (B)(i), or blending said components optionally in the presence of a solvent component (L)(i) and in the optional presence of a catalyst,
a₂) optionally reacting the fluorine-modified polyurethane prepolymer or the polyol mixture from stage a₁) with an optionally fluorine-modified functionalizing component (C)(i),
a₃) admixing the fluorine-modified polyurethane prepolymer or polyol mixture from stages a₁) or a₂) with a formulating component (F)(i), the formulating constituents being added individually or together before, during or after the reaction or blending of the individual components, and
b) a fluorine-modified polyurethane resin is prepared by reacting the fluorine-modified polyurethane prepolymer from stage a₃) in the case of a one-component application with atmospheric moisture, or reacting the fluorine-modified polyurethane prepolymer or polyol mixture from stage a₃) (binder) in the case of a two-component application with a crosslinker component (D) (curing agent), a formulating component (F)(ii), and, optionally, a solvent component (L)(iii), optionally in the presence of a catalyst, using as crosslinker component (D) in the case of the polyol mixture a polyisocyanate component (B)(iii) and in the case of the polyurethane prepolymer a polyisocyanate component (B)(iii) or a low molecular mass polyol component (A3)(ii) and/or a low molecular mass polyamine component (E), and adding the formulating constituents individually or together before, during or after the blending of the individual components.

53. The process of claim 52, wherein the fluorine-modified macromonomer (A1) is prepared by
c₁) reacting a fluoro alcohol component (A4) with the polyisocyanate component (B)(ii) optionally in the presence of a solvent component (L)(ii) and optionally in the presence of a catalyst, the reaction conditions and the selectivities of components (A4) and (B)(ii) being chosen such that only one isocyanate group of component (B)(ii) reacts with component (A4), and subsequently
c₂) optionally reacting the preadduct from stage c₁) completely with the functionalizing component (C)(ii), the reaction conditions and the selectivity of component (C)(ii) being chosen such that only one reactive group of component (C)(ii) reacts with the free isocyanate group(s) of the preadduct.

54. The process of claim 51, wherein reaction stages a₁) and a₂) are carried out at a temperature of from 40 to 120° C.

55. The process of claim 54, wherein the process is performed at a temperature of 50 to 110° C.

56. The process of claim 51, wherein reaction stages a₃) and b) are carried out at a temperature of from 10 to 60° C.

57. The process of claim 56, wherein the process is carried out at a temperature of 20 to 50° C.

58. The process of claim 51, wherein reaction stages c₁) and c₂) are carried out at a temperature of from −20 to 50° C.

59. The process of claim 58, wherein the process is performed at a temperature of 0 to 30° C.

60. A method comprising providing a permanent oil- and water-repellent surface treatment or modification of mineral and nonmineral substrates by applying the fluorine-modified polyurethane resin of claim 30 to a mineral or nonmineral substrate on an amount sufficient to provide a permanent oil- and water-repellent surface thereon.

61. The method of claim 60, wherein the mineral and nonmineral substrates are inorganic surfaces.

62. The method of claim 61, wherein the inorganic surfaces are selected from the group consisting of porous, absorbent, rough and polished construction material, an enamel, a filler and a pigment, a glass, a ceramic, a metal and a metal alloy.

63. The method of claim 60, wherein the mineral and nonmineral substrates are organic surfaces.

64. The method of claim 61 wherein the organic surfaces are selected from the group consisting of wood, a woodbase material, a wood veneer, a glass fiber-reinforced plastic (GRP), a plastic, leather, a natural fiber, a polar organic polymer, or a composite material.

65. The method of claim 60, wherein the coating is an antigraffiti/antisoiling coating; a easy to clean coating, a coating for a seal; a prefabricated concrete component, an adhesive, a sealant, a soundproofing for a wall, a corrosion control, a render or a decorative plaster, an external insulation and finishing system (EIFS) and external insulation system (EIS)

66. The method of claim 65, wherein the coating is a balcony coating, a roof (tile) coating, a baking varnished, a paint, a varnish, a masonry paint, a floor coating, a light-, medium- and heavy-duty industrial floors, a carpark surfacings or a sports floor.

67. The method of claim 60, wherein the coating is applied as an automotive coating, a coil coating, a baking varnish, a glass facade, and glass surface, a ceramic, a leather dressing, a surface-modified filler, a pigment a paper coating, a rotor of wind turbines, marine paints.

68. The method of claim 60, wherein in the construction or industrial sector for the integral water/oil repellency treatment of concrete.

69. The method of claim 60, wherein the, wherein it comprises concrete for prefabricated concrete components, concrete moldings, cast-in-place concrete, shotcrete, and ready-mix concrete.

70. The fluorine-modified polyurethane resin of claim 31, wherein as fluorine-modified macromonomer (A1) use is made of reaction products and/or macromonomers, with a monomodal molar mass distribution, of monofunctional perfluoroalkyl alcohols, isophorone diisocyanate or toluene diisocyanate, and diethanolamine.
